(19) United States
(12) Patent Application Publication
(10) Pub. No.: US 2025/0304852 A1
(43) Pub. Date: Oct. 2, 2025

(54) SELF-INVERTIBLE POLYMERIC WATER-IN-OIL EMULSION AND ITS USE AS FRICTION REDUCERS

(71) Applicant: Sterling Specialty Chemicals Holding UK Limited, Harrow (GB)

(72) Inventors: Hong YANG, Norcross, GA (US); Roopa TELLAKULA, Suwanee, GA (US); Danny NGUYEN, Buford, GA (US); Ronald ROBINSON, Newnan, GA (US); Ashleigh O'BRIEN, Marietta, GA (US)

(21) Appl. No.: 19/097,454

(22) Filed: Apr. 1, 2025

Related U.S. Application Data
(60) Provisional application No. 63/573,184, filed on Apr. 2, 2024.
(60) Provisional application No. 63/721,788, filed on Nov. 18, 2024.

(51) Int. Cl. C09K 8/64; E21B 43/26

(52) U.S. Cl. CPC C09K 8/64; E21B 43/26; C09K 2208/28

(57) ABSTRACT

A method of hydraulic fracturing, comprising producing an aqueous injection fluid by mixing a self-inverting water-in-oil emulsion comprising sulfonate terpolyacrylamide, wherein the self-inverting water-in-oil emulsion comprises from about 1 wt % to about 3 wt % of an oleyl ether polyglycol carboxylic acid of formula RO(CH₂CH₂O)n-CH₂COOH having a hydrophilic-lipophilic balance of about 5 to about 10, where n=about 3 to about 7, by weight of the emulsion composition.

### FIELD OF THE INVENTION

The present disclosure relates generally to emulsions, and more particularly, to emulsions that can be used as an additive in slickwater and/or high viscosity friction reducer (HVFR) fracturing fluids.

### BACKGROUND

In the drilling, completion, and stimulation of oil and gas wells, well treatment fluids are often pumped into well bore holes under high pressure and at high flow rates causing the rock formation surrounding the well bore to fracture. As the fluid is pumped through the pipe at high flow rates (thousands of GPM) there is a significant amount of frictional resistance, which results in large energy requirements.

To reduce the friction between the well treatment fluid and the bore linings, friction pressure reducing additives have been combined with the treatment fluids and added during pumping so as to reduce pump pressure. For example, a type of well treatment commonly utilized for stimulating hydrocarbon production from a subterranean zone penetrated by a well bore is hydraulic fracturing. Hydraulic fracturing, also referred to as fracing (or fracking), is used to initiate production in low-permeability reservoirs and re-stimulate production in older producing wells. In hydraulic fracing, a fluid composition is injected into the well at pressures effective to cause fractures in the surrounding rock formation. Fracing is used both to open up fractures already present in the formation and create new fractures.

Water soluble polymers can be used as friction reducers in well treatment fluids to alter the rheological properties of the fluid so that the turbulent flow is reduced, thereby preventing consequent energy loss in the fluid as it is pumped through the pipe. These types of treatments are often called “slick water treatments or slick water fracs.” In some instances, water soluble friction reducing polymers are suspended in water-in-oil emulsions, wherein upon addition to the aqueous treatment fluid, the emulsion must invert to release the friction reducing polymer into the fluid. Performance in the field depends (at least in part) upon the ability of the emulsions to invert, or break, quickly. Certain conditions in wells, for example high brine conditions, can hinder the breaking of the emulsion. In particular, high brines including potassium chloride, sodium chloride, seawater and other API base brines that include barium, strontium, iron, calcium or magnesium hardness can interfere with the inversion of emulsion polymers.

Poly(acrylamide-acrylic acid-acrylamide tertiary butyl sulfonic acid) (sometimes termed as sulfonate terpolyacrylamide herein) is used extensively as a friction reducer in high rate hydraulic fracturing with mid-to high-total dissolvable solid (TDS) produced water. Two product forms of the sulfonate terpolyacrylamide may be delivered to a field operator: solid dry particle and polymer water-in-oil emulsion. In contrast to demand hydration of solid dry particle products, polymer water-in-oil emulsions can easily be used with a fracking formulation by direct injection into the produced water (hydration on the fly).

Hydration of a polyacrylamide water-in-oil emulsion may be accomplished by inverting the emulsion with inverting surfactants. Luc Armanet and David Hunkeler (Journal of Applied Polymer Science, Vol. 103, 3567-3584 (2007)) found that when a wetting agent is mixed into a cationic polyacrylamide water-in-oil emulsion, the emulsion lattices can be rapidly dissolved in water. Water soluble wetting agent, when it contained a high percentage of hydrophilic group, could effectively destabilize a water-in-oil emulsion. EP3,604,351B1 generalized an inversion requirement by defining a mass ratio R of total inverting agent to total emulsifying agent used in polymerization, where the inverting agent takes between 0.5% and 6% by weight of polymer water-in-oil emulsion formulation. The emulsifying agent has HLB (hydrophilic-lipophilic balance) less than 10 and the inverting agent has HLB more than 10.

The following surfactants were found to be able to invert polyacrylamide water-in-oil emulsions: ethoxylated amine compounds (WO2016/109333A1), ethoxylated fatty acid compounds, alkyl polyethylene glycol ether and alkyl polyglycol ether carboxylic acid compounds (WO2018/045282), and ethoxylate alcohol (WO2021/016155A1).

Introduction of inverting surfactants may be carried out through adding the surfactants in the produced water prior to injection of the polymer water-in-oil emulsion. However, this way of inverting polymer water-in-oil emulsion requires at least one more surfactant feeding pump. Attempts to render the emulsions self-inverting, whereby the polymer can be dispersed in aqueous solutions, have generally not been successful as a result of coagulation or agglomeration of polymer.

U.S. Pat. No. 4,052,353 teaches that a self-dissolving composition of finely divided water soluble polymer dispersed in oil is produced by providing a water in oil emulsion having finely divided water soluble polymer dispersed therein, reducing the water content of the emulsion to a value at which the polymer remains finely divided and dispersed in the oil upon addition of a surfactant to render the composition self-dissolving.

### SUMMARY

An object of the present invention is to provide treatment fluid comprising an emulsion, the emulsion comprising water, a water-immiscible liquid, poly(acrylamide-acrylic acid-acrylamide tertiary butyl sulfonic acid), and oleyl ether polyglycol carboxylic acid component of formula RO(CH₂CH₂O)n-CH₂COOH and/or salts or esters thereof, in an amount of from about 1 wt % to about 3 wt % (by weight of the emulsion composition), where n=about 3 to about 7.

Optionally, n may be about 3 to about 5. For example, in one aspect, n may be 3, 4 or 5.

According to another aspect, the oleyl ether polyglycol carboxylic acid may have a hydrophilic-lipophilic balance of about 5 to about 10.

In specific embodiments, the oleyl ether polyglycol carboxylic acid may have a hydrophilic-lipophilic balance of 5 to 9.6.

Optionally, the oleyl ether polyglycol carboxylic component comprises oleyl ether polyglycol carboxylic acids and/or salts or esters thereof having different n values which in combination result in a weight average of n=about 3 to about 7, or about 3 to about 5.

According to yet another aspect, the invention provides a method of forming a self-inverting water-in-oil emulsion, comprising adding to the emulsion an oleyl ether polyglycol carboxylic acid component of formula RO(CH₂CH₂O)n-CH₂COOH, and/or salts or esters thereof, in an amount of from about 1 wt % to about 3 wt % (by weight of the emulsion composition), where n=about 3 to about 5.

In various embodiments of the method, n may be 3, 4 or 5; the oleyl ether polyglycol carboxylic acid and/or salts or esters thereof, may have a hydrophilic-lipophilic balance of about 5 to about 10 or, in specific embodiments, a hydrophilic-lipophilic balance of 5 to 9.6.

Also provided is a method of treating a subterranean formation, comprising: providing a treatment fluid as described herein and introducing the treatment fluid into a subterranean formation.

### BRIEF DESCRIPTION OF THE DRAWING

A more complete appreciation of the present disclosure and many of the attendant advantages thereof will be readily obtained as the same becomes better understood by reference to the following detailed description when considered in connection with the accompanying drawings, wherein:

FIG. 1 shows the structure of oleyl ether polyglycol carboxylic acids for use in the present invention.

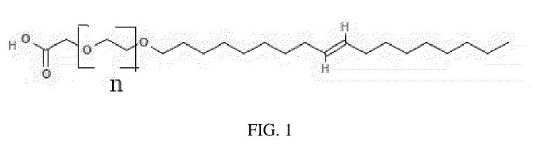

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

Various embodiments of this invention provide a treatment fluid useful in operations to recover oil from subterranean formations. The treatment fluid comprises a self-invertible water-in-oil emulsion comprising water, oil or another suitable water-immiscible liquid, and sulfonate terpolyacrylamide to which is added an effective amount, e.g., about 1%, up to about 2% of a self-inverting surfactant composition comprising oleyl ether polyglycol carboxylic acid of a general formula RO—(CH₂CH₂O)ₙ—CH₂COOH (where RO=oleyl alcohol radical), and/or salts or esters thereof. Optionally, an oleyl ether polyglycol carboxylic acid composition may be derived from oleylic fatty acid, by subjecting the fatty acid to ethoxylation to produce an alkyl ethoxylate alcohol and oxidizing the alcohol to a carboxylic acid.

Suitable sulfonate terpolyacrylamide water-in-oil emulsions may be prepared using a variety of suitable water-immiscible liquids such as paraffin hydrocarbons, naphthene hydrocarbons, aromatic hydrocarbons, olefins, oils, stabilizing surfactants and mixtures thereof. The paraffin hydrocarbons may be saturated, linear, or branched paraffin hydrocarbons. Examples of suitable aromatic hydrocarbons include, but are not limited to, toluene and xylene. In one embodiment, the water-immiscible liquid is an olefin and paraffin blend. In another embodiment, the water-immiscible liquid comprises oil and one or more emulsifiers. The water-immiscible liquid may be present in the emulsion in an amount sufficient to form a stable emulsion. In some embodiments, the water-immiscible liquid may be present in the emulsions in an amount in the range of from about 20% to about 60%, about 25% to about 55%, about 35% to about 55%, or about 20% to about 30% by weight.

The sulfonate terpolyacrylamide should be present in the emulsion in an amount that does not undesirably impact the emulsion's stability. In addition or instead of sulfonate terpolyacrylamide, there may be other polymers in the emulsion, such as polyacrylamide, for example an emulsion polyacrylamide that can be used as a friction-reducing polymer. The term “friction reducing polymer” refers to a polymer that reduces energy losses due to friction between an aqueous fluid in turbulent flow and tubular goods, e.g. pipes, coiled tubing, and the like, and/or formation. The friction reducing polymer is not intended to be limited to any particular type and may be synthetic polymers, natural polymers, or viscoelastic surfactants. Suitable friction reducing polymers are typically latex polymers or copolymers of acrylamides, acrylates, guar gum, polyethylene oxide, and combinations thereof. The friction reducing polymers may be anionic, cationic, amphoteric or non-ionic depending on desired application. In addition, various combinations can be used including but not limited to hydrophilic/hydrophobic combinations, functionalized natural and/or synthetic blends of the above, or the like. In certain exemplary embodiments, the friction reducing polymer is anionic. In certain exemplary embodiments, the friction reducing polymer is cationic. In certain exemplary embodiments, the friction reducing polymer is non-ionic. In certain exemplary embodiments, the friction reducing polymer is amphoteric.

In exemplary embodiments, the polymer is a polymer useful in emulsion compositions or an emulsion polymer.

In exemplary embodiments, the polymer is an emulsion polyacrylamide (EPAM). EPAMs are generally inverse emulsions (water-in-oil) in which water droplets containing the polymer are suspended in an oil phase.

In exemplary embodiments, the polymer is a polymer useful for enhanced oil recovery applications. The term “enhanced oil recovery” or “EOR” (also known as tertiary mineral oil production) refers to a process for mineral oil production in which an aqueous injection fluid comprising at least a water-soluble polymer is injected into a mineral oil deposit. The techniques of tertiary mineral oil production include what is known as “polymer flooding”. Polymer flooding involves injecting an aqueous solution of a water-soluble thickening polymer through the injection boreholes into the mineral oil deposit. As a result of the injection of the polymer solution, the mineral oil is forced through the cavities in the formation, proceeding from the injection borehole, in the direction of the production borehole, and the mineral oil is produced through the production borehole. By virtue of the fact that the polymer formulation has an increased viscosity as compared to the viscosity of water, the risk is reduced that the polymer formulation breaks through to the production borehole. It is thus possible to mobilize additional mineral oil in the formation. Details of polymer flooding and of polymers suitable for this purpose are disclosed, for example, in “Petroleum, Enhanced Oil Recovery, Kirk-Othmer, Encyclopedia of Chemical Technology, online edition, John Wiley & Sons, 2010”. For polymer flooding, a multitude of different water-soluble thickening polymers have been proposed, especially high molecular weight polyacrylamide, copolymers of acrylamide and further comonomers, for example vinyl sulfonic acid or acrylic acid. Polyacrylamide may be partly hydrolyzed polyacrylamide, in which some of the acrylamide units have been hydrolyzed to acrylic acid. It is known in the art to use inverse emulsions of polyacrylamide (co) polymers for enhanced oil recovery (EOR) in particular for use on off-shore platforms. Such inverse emulsions typically comprise about 30 wt. % of polymers. For use inverse emulsions are simply diluted with water to the final concentration of the polymer.

In exemplary embodiments, the one or more polymers is water soluble. In exemplary embodiments, the one or more polymers comprises an acrylamide-containing polymer. In exemplary embodiments, the one or more polymers consists essentially of acrylamide-containing polymers. In exemplary embodiments, the one or more polymers comprises polyacrylamide, copolymers of acrylamide, sulfonated polyacrylamide, cationic polyacrylamide, anionic polyacrylamide, and partially hydrolyzed acrylamide. In exemplary embodiments, the one or more polymers comprises acrylamide or partially hydrolyzed acrylamide and one or more nonionic and/or anionic monomers.

Suitable non-ionic monomers include but are not limited to acrylamide, N-alkylacrylamides, N,N-dialkylacrylamides, methacrylamide, N-vinyl methylacetamide or formamide, vinyl acetate, vinylpyrrolidone, alkyl methacrylates, acrylonitrile, N-vinylpyrrolidone other acrylic (or other ethylenically unsaturated) ester or other water insoluble vinyl monomers such as styrene or acrylonitrile.

The term “anionic monomer” refers to a monomer which possesses a negative charge. Representative anionic monomers include acrylic acid, sodium acrylate, ammonium acrylate, methacrylic acid, 2-acrylamido-2-methylpropanesulfonic acid (AMPS), vinyl sulfonic acid, styrene.

In a particular embodiment, the one or more polymers comprises acrylamide or partially hydrolyzed acrylamide and one or more anionic monomers. In exemplary embodiments, the one ormore polymers has an overall anionic charge and comprises acrylamide or partially hydrolyzed acrylamide and one or more nonionic and/or anionic monomers. In exemplary embodiments, the one or more polymers comprises about 5% to about 60% anionic monomers by weight. In exemplary embodiments, the one or more polymers comprises an anionic polyacrylamide. In exemplary embodiments, the anionic polyacrylamide is a copolymer comprising one or more anionic monomers and acrylamide monomers. Exemplary salts of these anionic monomers include but are not limited to sodium and ammonium salts. In one embodiment, the polymer is an anionic polymer. In a particular embodiment, the anionic polymer has about 5% to about 60% charge, about I 0% to about 50% charge, about 15% to about 45% charge, about 20% to about 40% charge, about 10% to about 15% charge, or about 25% to about 35% charge.

In exemplary embodiments, the one or more polymers comprises acrylamide or partially hydrolyzed acrylamide and one or more cationic monomers.

The term “cationic monomer” refers to a monomer which possesses a positive charge. Representative cationic monomers include dialkyl aminoalkyl acrylates and methacrylates and their quaternary or acid salts, including, but not limited to, dimethyl aminoethyl acrylate methyl chloride quaternary salt, dimethyl aminoethyl acrylate methyl sulfate quaternary salt, dimethyl aminoethyl acrylate benzyl chloride quaternary salt, dimethyl aminoethyl acrylate sulfuric acid salt, dimethyl aminoethyl acrylate hydrochloric acid salt, diethyl aminoethyl acrylate, methyl chloride quaternary salt, dimethyl aminoethyl methacrylate methyl chloride quaternary salt, dimethyl aminoethyl methacrylate methyl sulfate quaternary salt, dimethyl aminoethyl methacrylate benzyl chloride quaternary salt, dimethyl aminoethyl methacrylate sulfuric acid salt, dimethyl aminoethyl methacrylate hydrochloric acid salt, dimethyl aminoethyl methacryloyl hydrochloric acid salt, dialkyl aminoalkyl acrylamides or methacrylamides and their quaternary or acid salts such as acrylamido propyl trimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacryl amido propyl trimethyl ammonium chloride, dimethyl aminopropyl methacrylamide methyl sulfate quaternary salt, dimethylaminopropyl methacrylamide sulfuric acid salt, dimethylaminopropyl methacrylamide hydrochloric acid salt, acryloyloxy ethyl trimethyl ammonium chloride, diethylamino ethylacrylate, diethyl aminoethyl methacrylate and diallyl dialkyl ammonium halides such as diallyl diethyl ammonium chloride and diallyl dimethyl ammonium chloride. The alkyl groups are generally C₁₋₈ alkyl.

In a particular embodiment, the one or more polymers comprises acrylamide or partially hydrolyzed acrylamide and one or more cationic monomers. In a particular embodiment, the one or more polymers comprises acrylamide or partially hydrolyzed acrylamide and acryloyloxyethyl trimethyl ammonium chloride. In exemplary embodiments, the one or more polymers has an overall cationic charge and comprises acrylamide or partially hydrolyzed acrylamide and one or more cationic monomers. In exemplary embodiments, the one or more polymers comprises about 5% to about 60% cationic monomers by weight. In exemplary embodiments, the one or more polymers comprises a cationic polyacrylamide. In exemplary embodiments, the cationic polyacrylamide is a copolymer comprising one or more cationic monomers and acrylamide monomers. In one embodiment, the polymer is a cationic polymer.

In exemplary embodiments, the partially hydrolyzed acrylamide is acrylamide wherein about 3% to about 70% of the amide groups have been hydrolyzed to carboxyl groups.

In one embodiment, the one or more polymers comprises an amphoteric polymer. In one embodiment, the one or more polymers comprises a non-ionic polymer.

In exemplary embodiments, the one or more polymers comprises acrylamide or partially hydrolyzed acrylamide and one or more monomers selected from the group consisting of acrylic acid, acrylate salt, 2-acrylamido-2-methylpropane sulfonic acid, N,N-dimethylacrylamide, vinyl sulfonic acid, N-vinyl sulfonic acetamide, N-vinyl formamide, itaconic acid, methacrylic acid, acryloyl oxyethyl trimethyl ammonium chloride, salts thereof, and combinations thereof In a particular embodiment, the one or more polymers comprises acrylamide or partially hydrolyzed acrylamide and one or more monomers selected from the group consisting of acrylic acid, 2-acrylamido-2-methylpropane sulfonic acid, and methacrylic acid, and salts thereof. In a particular embodiment, the one or more polymers comprises acrylamide or partially hydrolyzed acrylamide and one or more monomers selected from the group consisting of acrylic acid and salts thereof.

In certain embodiments, the polymer comprises acrylamide and one or more monomers selected from the group consisting of: acrylic acid and its salts, methacrylamide, methacrylic acid and its salts, maleic acid and its salts, methyl acrylate, ethyl acrylate, propyl acrylate, methyl methacrylate, ethyl methacrylate, dimethyl aminoethyl acrylate and its methyl chloride and methosulfate quaternaries, dimethyl aminoethyl methacrylate and its methyl chloride and methosulfate quaternaries, diethyl aminoethyl acrylate and its methyl chloride and methosulfate quaternaries, diethyl aminoethyl methacrylate and its methyl chloride and methosulfate quaternaries, hydroxyethyl acrylate, hydroxyethyl methacrylate, styrene, acrylonitrile, 2-acrylamido-2-methylpropane sulfonic acid and its salts, 3-(methylacrylamido)-propyltrimethyl ammonium chloride, dimethyl aminopropyl methacrylamide, isopropyl aminopropyl methacrylamide, methacryl amidopropyl hydroxyethyl dimethyl ammonium acetate, vinyl methyl ether, vinyl ethyl ether, alkali metal and ammonium salts of vinyl sulfonic acid, vinyl pyridine, vinyl pyrrolidone, vinyl imidazole, diallyl dimethyl ammonium chloride, styrene sulfonic acid and its salts, and the like.

In exemplary embodiments, one or more polymers is a copolymer of acrylamide or partially hydrolyzed acrylamide and one or more anionic monomers. In exemplary embodiments, the one or more polymers comprises at least about 40 mole %, about 50 mole %, about mole 60%, about mole70%, about mole 80%, or about mole 90% acrylamide or partially hydrolyzed acrylamide. In exemplary embodiments, the one or more polymers comprises at least about 5 mole %, about 10 mole %, about 20 mole %, about 30 mole %, about 40 mole %, about 50 mole %, or about 55 mole % one or more anionic monomers. In exemplary embodiments, the one or more polymers comprises about 40 mole % to about 95 mole %, or about 60 mole % to about 90 mole %, acrylamide or partially hydrolyzed acrylamide. In exemplary embodiments, the one or more polymers comprises about 5 mole % to about60 mole %, or about 10 mole % to about 40 mole %, one or more anionic monomers.

In exemplary embodiments, one or more polymers is a copolymer of acrylamide or partially hydrolyzed acrylamide and one or more cationic monomers. In exemplary embodiments, the one or more polymers comprises at least about 40 mole %, about 50 mole %, about mole 60%, about mole70%, about mole 80%, or about mole 90% acrylamide or partially hydrolyzed acrylamide. In exemplary embodiments, the one or more polymers comprises at least about 5 mole %, about 10 mole %, about 20 mole %, about 30 mole %, about 40 mole %, about 50 mole %, or about 55 mole % one or more cationic monomers. In exemplary embodiments, the one or more polymers comprises about 40 mole % to about 95 mole %, or about 60 mole % to about 90 mole %, acrylamide or partially hydrolyzed acrylamide. In exemplary embodiments, the one or more polymers comprises about 5 mole % to about60 mole %, or about 10 mole % to about 40 mole %, one or more cationic monomers.

In exemplary embodiments, one or more polymers Is a copolymer of acrylamide or partially hydrolyzed acrylamide and acrylic acid or an acrylate salt. In exemplary embodiments, the one or more polymers comprises at least about 40 mole %, about 50 mole %, about mole 60%, about mole 70%, about mole 80%, or about mole 90% acrylamide or partially hydrolyzed acrylamide. In exemplary embodiments, the one or more polymers comprises at least about 5 mole %, about 10 mole %, about20 mole %, about 30 mole %, about 40 mole %, about 50 mole %, or about 55 mole % acrylic acid or acrylate salts. In exemplary embodiments, the acrylate salt comprises ammonium acrylate. In exemplary embodiments, the one or more polymers comprises about 40 mole % to about 95 mole %, or about 60 mole % to about 90 mole %, acrylamide or partially hydrolyzed acrylamide. In exemplary embodiments, the one or more polymers comprises about 5 mole % to about 60 mole %, or about 10 mole % to about 40 mole %, acrylic acid or an acrylate salt.

The exemplary polymers may be included in the treatment fluids in an amount sufficient to provide the desired properties. In some embodiments, a polymer may be present in an amount in the range of about 0.1 to about 10, about 0.1 to about 6, about 0.1 to about 5, or about 0.25 to about 1,Gallons Per Thousand Gallons of the aqueous treatment fluid (GPTG). The polymers may be added to slick water treatments at concentrations of about 0.1 to about 20 GPTG, of treatment fluid. In other embodiments, the polymer is added at a concentration of about 0.25 to about 6 GPTG of treatment fluid.

The polymers of the present embodiments should have a molecular weight sufficient to provide desired properties. For example, those polymers used for friction reduction should have higher molecular weights to provide a desirable level of friction reduction. The polymers used for EOR applications should have sufficient molecular weight to provide the desired viscosity to mobilize oil in a desirable manner. In some exemplary embodiments, the weight average molecular weight of a polymer may be in the range of from about 7,500,000 to about 30,000,000 Dalton. Those of ordinary skill in the art will recognize that polymers having molecular weights outside the listed range may still provide desirable properties in the aqueous treatment fluid.

In exemplary embodiments, the polymer is used for EOR applications.

Suitable polymers of the present embodiments may be in an acid form or in a salt form. A variety of salts may be made by neutralizing the acid form of a monomer, for example acrylic acid or 2-acrylamido-2-methylpropane sulfonic acid, with a base, such as sodium hydroxide, ammonium hydroxide or the like. As used herein, the term “polymer” is intended to include both the acid form of the copolymer and its various salts.

In exemplary embodiments, the sulfonate terpolyacrylamide and/or one or more other polymers disclosed herein may be present in an amount in the range of from about 10% to about 80%, about 10% to about 35%, about 15% to about 30%, or about 20% to about 30%, about 39% to about 80%, or about 40% to about 60%, or about 45% to about 55%, by weight of the emulsion. In exemplary embodiments, the emulsion may comprise greater than about 35%, about 39%, 40%, 41%, 42%, 43%, 44%, 45%, 46%, 47%, 48%, 49%, 50%, 51%, 52%, 53%, 54%, 55%, 56%, 57%, 58%, 59% or about 60% or higher, by weight polymer. In exemplary embodiments, the emulsion may comprise less than about 35%, or about 30%, or less, by weight polymer. In exemplary embodiments, the polyacrylamide, being hydrophilic, is contained within water droplets that are dispersed in a continuous oil phase, and may be prepared by solution polymerization. Methods for the preparation of exemplary aqueous polymer dispersions are well known in the art, for example as described in U.S. Pat. No. 5,200,448. The oil phase of the emulsion, which generally comprises from about 5 to about 35 percent by weight of the total emulsion, is comprised of one or more inert hydrophobic liquids.

The oil phase may comprise about 20 to 30 percent of the emulsion. The oil used may be selected from a large class of organic liquids which are immiscible with water, including liquid hydrocarbons and substituted liquid hydrocarbons. Representative examples of such oils include benzene, xylene, toluene, mineral oils, kerosenes, naphthas, chlorinated hydrocarbons, such as perchloroethylene, and the like. The oil phase may contain one or more primary or emulsifying surfactants, i.e. conventional emulsion polymerization stabilizers. Such stabilizers are well known to the art to promote the formation and stabilization of water-in-oil emulsions. Normally such emulsifiers have HLB values in the range of about 2 to about 10, preferably less than about 7. Suitable such emulsifiers include the sorbitan esters, phthalic esters, fatty acid glycerides, glycerine esters, as well as the ethoxylated versions of the above and any other well-known relatively low HLB emulsifier. Examples of such compounds include sorbitan monooleate, the reaction product of oleic acid with isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, and the ethoxylated versions thereof containing 1 to 10 moles of ethylene oxide per mole of the basic emulsifier. Thus, any emulsifier may be utilized which will permit the formation of the initial emulsion and stabilize the emulsion during the polymerization reaction. These primary surfactants are used alone or in mixtures and are utilized in amounts of not greater than about 5%, about 4%, about 3%, about 2% or about 1% by weight of the total emulsion.

The aqueous phase generally comprises about 95 to 65% by weight of the initial emulsion, optionally about 80 to 70% thereof. In addition to water, the aqueous phase may contain the monomers being polymerized, generally in an amount of less than about 50%, about 15 to about 40%, or about 22 to about 35%, by weight of the total emulsion, and generally chain transfer agents, initiators and sequesterants. Alternatively, the chain transfer agents, initiators and sequesterants may be added to the system after the preliminary emulsion has been prepared. The initiator may also be added continuously during the polymerization to control the rate of polymerization depending upon the particular monomers used and their reactivities. Alternatively, the initiator may be present in either the oil or the aqueous phase with the monomers being added either continuously or incrementally thereafter. All of these variations are well known in the art.

In an exemplary embodiment, the treatment fluid comprises water and an exemplary emulsion described herein. The treatment fluids may be prepared by mixing an exemplary emulsion with water. The additional water that is mixed with the emulsion to form the treatment fluid may be freshwater, saltwater (e.g. water containing one or more salts dissolved therein), brine (e.g. produced from subterranean formations), seawater, or combinations thereof. Generally, the water used may be from any source, provided that it does not contain an excess of compounds that may adversely affect other components in the aqueous treatment fluid or the formation itself. In certain exemplary embodiments, the water is brine with a total dissolved solids content (TDS) of about 5,000 to about 300,000 ppm, or about 100,000 to about 260,000 ppm. In certain exemplary embodiments, the total divalent cationic species content of the brine is in the range of about 5,000 to about 100,000 ppm, or about 10,000 to about 50,000 ppm.

In various embodiments, n in the oleyl ether polyglycol carboxylic acid surfactant composition added to the sulfonate terpolyacrylamide water-in-oil emulsion may range from about 3 to about 7, or optionally about 3 to about 5. In specific embodiments, n may be 3, 4 or 5. The value of n in an oleyl ether polyglycol carboxylic acid (i.e., the number of glycol units) is sometimes indicated as an EO #value, e.g., n=3 is sometimes shown as EO3; n=5 may be shown as EO5, etc. Optionally, the value of n in the formula RO(CH₂CH₂O)n-CH₂COOH of the oleyl ether polyglycol carboxylic acid component may optionally be an average of n values of oleyl ether polyglycol carboxylic acids of different n values. For example, an oleyl ether polyglycol carboxylic acid component composed of a 50:50 blend of oleyl ether polyglycol carboxylic acid of EO2 with oleyl ether polyglycol carboxylic acid of EO5 would produce a combined oleyl ether polyglycol carboxylic acid component of n=3.5.

In various embodiments, the oleyl ether polyglycol carboxylic acid surfactant composition may have an HLB of from about 5 to about 10.

The addition of the oleyl ether polyglycol carboxylic acid components as described herein can build viscosity and provide reduction of friction in slickwater and/or high viscosity friction reducer (HVFR) fracturing fluids.

### Methods of Use

The emulsions and treatment fluids of the present embodiments may be used in any subterranean treatment. Such subterranean treatments include, but are not limited to, drilling operations, stimulation treatments, and completion operations. Those of ordinary skill in the art, with the benefit of this disclosure, will be able to recognize a suitable subterranean treatment. In exemplary embodiments, the emulsion comprises: water; a water-immiscible liquid; about 10% to about 80% by weight one or more polymers; and about 0.1% to about 5% by weight an exemplary inverting surfactant composition described herein.

In exemplary embodiments, the methods may further comprise preparing the treatment fluid, or aqueous treatment fluid. Preparing the treatment fluid may comprise providing an emulsion as described herein, and combining the emulsion with water to form the treatment fluid. In exemplary embodiments, a method of treating a subterranean formation comprises providing a treatment fluid comprising an exemplary emulsion described herein, and introducing the treatment fluid into a subterranean formation.

In exemplary embodiments, methods for improving friction reduction properties of a treatment fluid, comprising: (i) providing an exemplary emulsion as described herein; and (ii) inverting the emulsion in the treatment fluid comprising brine. In certain embodiments, the resultant treatment fluid has an improvement in friction reduction, when compared to a similar treatment fluid in which the inverted emulsion is other than an exemplary inverting surfactant composition as described herein.

The inverting surfactant compositions, emulsions and treatment fluids of the present embodiments may have various uses, for example in crude oil development and production from oil bearing formations that can include primary, secondary or tertiary (enhanced) recovery. Chemical techniques, including for example injecting surfactants (surfactant flooding) to reduce interfacial tension that prevents or inhibits oil droplets from moving through a reservoir or injecting polymers that allow the oil present to more easily mobilize through a formation, can be used before, during or after implementing primary and/or secondary recovery techniques. Such techniques can also be used for enhanced oil recovery, or to complement other enhanced oil recovery techniques.

The inverting surfactant compositions, emulsions and treatment fluids of the present embodiments may be used in any oil recovery technique, for example an oil recovery technique where the reduction of friction or interfacial tension is desired, or where mobilization of oil is desired. In exemplary embodiments, a method comprising using an inverting surfactant composition, emulsion or treatment fluid as described herein may be utilized for oil recovery, including but not limited to enhanced oil recovery. In exemplary embodiments, the method comprises providing a treatment fluid comprising an emulsion comprising one or more polymers and an exemplary inverting surfactant composition described herein; and introducing the treatment fluid into a subterranean formation; and recovering hydrocarbons from the subterranean formation. In exemplary embodiments, the method comprises providing an emulsion comprising one or more polymers and an exemplary inverting surfactant composition described herein; and introducing the emulsion into a subterranean formation; and recovering hydrocarbons from the subterranean formation.

The term “brine” or “aqueous brine” as used herein refers to sea water; naturally-occurring brine; a chloride-based, bromide-based, formate-based, or acetate-based brine containing monovalent and/or polyvalent cations or combinations thereof. Examples of suitable chloride-based brines include without limitation sodium chloride and calcium chloride. Further without limitation, examples of suitable bromide-based brines include sodium bromide, calcium bromide, and zinc bromide. In addition, examples of formate-based brines include without limitation, sodium formate, potassium formate, and cesium formate.

The following examples are presented for illustrative purposes only, and are not intended to be limiting.

### EXAMPLES

### Example 1—Preparation of Prior Art Fracturing Fluid

A sulfonate terpolyacrylamide water-in-oil emulsion representative of prior art fracturing fluid, in which water droplets containing the polymer are suspended in an oil phase, was prepared by standard emulsion procedures, i.e., by polymerization of the monomers acrylamide, sodium acrylate and sodium acrylamido-tert-butyl sulfonate (Na-ATBS), resulting in about 33% polymer by weight of the emulsion. The resulting emulsion is referred to herein by the label EPAM 1. Two other similar sulfonate terpolyacrylamide water-in-oil emulsions were also prepared with differing molar ratios and labelled as EPAM 2 and EPAM 3. About 30 g of each EPAM sample was made in a 29.6 ml (2 oz.) glass jar with a three-arm propeller type stainless steel stirrer. Each EPAM emulsion was first weighed in the glass jar and the stirrer was inserted then rotated at around 600 rpm.

Oleyl ether glycol carboxylic acid inverting surfactants E1 and E3, and comparative inverting surfactants C2, C4, C5, C6 and C7 were administered to separate volumes of EPAM 1 with a plastic pipette over a period of 1 to 5 minutes depending on the mixtures' consistency, for instance, close to 5 minutes at high consistencies. The inverting surfactants E1 and E3, and C2, C4, C5, C6 and C7 all had the same basic formula general formula RO—(CH₂CH₂O)ₙ—CH₂COOH, differing from each other by their respective RO— groups and the number of ethoxylate groups —(CH₂CH₂O)ₙ as characterized in Table 1C. E1 was an EO5 oleyl ether polyglycol carboxylic acid, while E3 was an EO3 oleyl ether polyglycol carboxylic acid. Each inverting surfactant was added as 3% by weight of the resulting mixture with EPAM 1. Each resulting mixture was then mixed for at least 30 minutes and was subjected to the following tests.

Appearance test: Each resulting mixture was observed over a period of 3 days following the addition of the inverting surfactant, to determine the stability of the resulting emulsion; the desired outcome being that the sample maintained a free-flowing state after the observation period. Free-flowing emulsions were marked as ‘fluid’ and the ones that were very viscous and not free flowing anymore were marked as ‘gels’.

Hydration test: An aqueous test brine was prepared using the salts listed in the following Table 1B:

TABLE 1B
brine formulation

| | (wt % |
|---|---|
| Salt | Salt/solution) |
| NaCl | 7.046 |
| KCl | 0.081 |
| MgCl₂•6H₂O | 0.475 |
| CaCl₂•2H₂O | 0.849 |
| SrCl₂•6H₂O | 0.245 |
| BaCl₂•2H₂O | 0 |
| Na₂SO₄ | 0.073 |
| NaHCO₃ | 0.026 |
| FeCl₂•4H₂O | 0.004 |
| Na₂B₄O₇•10H₂O | 0.025 |

400 g of brine was used to evaluate the pre-loaded emulsions. The brine was first weighed in the mixer. Then 2 gpt (gallon per thousand) emulsion samples were administered via a 1 mL syringe into the brine under 1500 rpm shear. The mixing was conducted for 50 seconds. Thereafter, the solution was transferred to the container of OFITE Model 900 Viscometer. Viscosity at 300 rpm was measured for a total of 15 minutes.

Friction Reduction: Friction reduction measurements were performed on a laboratory scale friction loop designed to simulate well fracturing flow conditions. The friction loop simulates the field conditions to the maximum known extent (Reynolds number: 120,000). The data generated by this laboratory scale friction loop is accurate and widely accepted by the industry. The main components of the friction loop are: pump, magnetic flow meter and a differential pressure transmitter to create and monitor necessary conditions. All pipes and other components are constructed using stainless steel 316L/304L material. To test the friction reduction property of the example materials, the friction loop reservoir was filled with 20 L of synthesized brine per Table 1B. This brine was then recirculated through the friction loop at a flow rate of 24 gallons per minute across a five-foot section of half-inch diameter pipe (required to generate the abovementioned Reynolds number). The baseline pressure drop was measured. The exemplary materials were now added (at a measured concentration of polymer equivalent to 150 ppm in 20 L brine) to the recirculating brine solution. The degree of friction reduction (% FRt) at a given time ‘t’ was calculated from the initial pressure drop ΔPi and the pressure drop at time t, ΔPt using the equation: % FRt={[ΔPi−ΔPt]/ΔPi}×100

The results of the foregoing tests are summarized in the following Table 1C:

TABLE 1C

| | | | | | OFITE |
|---|---|---|---|---|---|
| Ex- | | | | | viscosity at |
| am- | Inverting Surfactant | | | | 300 rpm |
| ple | Chemistry | EO | HLB* | Appearance [symbol] | (cP) |
| E1 | Oleyl ether glycol | 5 | 9.6 | Fluid | 3.9 |
| | carboxylic acid | | | | |
| C2 | Oleyl ether glycol | 10 | 13.0 | Gel | 3.7 |
| | carboxylic acid | | | | |
| E3 | Oleyl ether glycol | 3 | 5.0 | Fluid | 3.4 |
| | carboxylic acid | | | | |
| C4 | Tridecyl ether glycol | 8 | 12.0 | Gel | 3.3 |
| | carboxylic acid | | | | |
| C5 | Dodecyl ether glycol | 4 | 5.5 | Gel | 3.6 |
| | carboxylic acid | | | | |
| C6 | Octyl ether glycol | 6 | 11-14 | Gel | No test |
| | carboxylic acid | | | | |
| C7 | Butyl ether glycol | 1 | ~8.7 | Gel | 2.6 |
| | carboxylic acid | | | | |

*as reported by manufacturers [symbol]
physical state changes from fluid to gel in 3 days' time period is denoted as gel.

Examples E1 and E3 exhibit properties of a surprisingly stable self-invertible water-in-oil emulsion.

### Example 2

EO3 and E05 oleyl ether polyglycol carboxylic acid surfactant compositions were administered to EPAM 1 in the manner described in Example 1 in proportions ranging from 1 wt % to 2 wt % of the weight of oleyl ether polyglycol carboxylic acid plus EPAM 1, and observations were made of Appearance, viscosity (measured using an OFITE viscometer model 900 at 300 rpm (cP)), and friction reduction (FR). FR results are reported as maximum FR, the time to reach the Maximum FR, and the time to reach 90% maximum FR. The results are summarized in Table 2A (n=3) and Table 2B (n=5).

TABLE 2A

| | | Oleyl ether | | | | | |
|---|---|---|---|---|---|---|---|
| | | glycol | | OFITE | | | |
| | | carboxylic | | viscosity | | | |
| | | acid | | at | Max. | | |
| | | EO3 | | 300 rpm | FR | Tmax | T90 |
| EPAM | Sample | wt % | Appearance | (cP) | (%)* | (s)* | (s)* |
| EPAM | E12 | 1.00% | Fluid | 3.3 | 64 | 100 | 43 |
| 1 | E13 | 1.25% | Fluid | 3.0 | 65 | 70 | 31 |
| | E14 | 1.50% | Fluid | 3.3 | 65 | 58 | 25 |
| | E15 | 2.00% | Fluid | 3.3 | 64 | 50 | 23 |

TABLE 2B

| | | Oleyl ether | | | | | |
|---|---|---|---|---|---|---|---|
| | | glycol | | OFITE | | | |
| | | carboxylic | | viscosity | Max. | | |
| | | acid | | at 300 | FR | Tmax | T90 |
| EPAM | Sample | EO5 wt % | Appearance | rpm (cP) | (%)* | (s)* | (s)* |
| EPAM 1 | E8 | 1.00% | Fluid | 4.3 | 62 | 92 | 41 |
| | E9 | 1.25% | Fluid | 4.1 | 65 | 50 | 25 |
| | E10 | 1.50% | Fluid | 4.1 | 66 | 46 | 21 |
| | E11 | 2.00% | Fluid | 3.6 | | | |

*where Max. FR is the maximum friction reduction at time of Tmax. T90 is the time at which the friction reduction reaches 90% of maximum friction reduction.

The results of Table 2A and Table 2B show that unpredicted superior results were attained at surfactant loading of less than 3 wt %.

### Example 3

Oleyl ether glycol carboxylic acid surfactant with n=5 was added to EPAM 2 and EPAM 3 at loadings of 1 wt %, 1.25 wt % and 1.5 wt % by combined weight of surfactant+EPAM, and observations were taken as in Example 2. The results are presented in Table 3.

TABLE 3

| | | Oleyl ether | | OFITE | | | |
|---|---|---|---|---|---|---|---|
| | | glycol | | viscosity | | | |
| | | carboxylic | | at 300 | Max. | | |
| | Exam- | acid | | rpm | FR | Tmax | T90 |
| EPAM | ple | EO5 wt % | Appearance | (cP) | (%)* | (s)* | (s)* |
| EPAM | E16 | 1.00% | Fluid | 4.2 | 61 | 130 | 69 |
| 2 | E17 | 1.25% | Fluid | 4.2 | 62 | 62 | 33 |
| | E18 | 1.50% | Fluid | 4.3 | 63 | 50 | 25 |
| EPAM | E19 | 1.00% | Fluid | 3.9 | 64 | 98 | 53 |
| 3 | E20 | 1.25% | Fluid | 4.1 | 65 | 56 | 25 |
| | E21 | 1.50% | Fluid | 4.1 | 65 | 44 | 21 |

The data of Table 3 show that oleyl ether polyglycol carboxylic acid with n=5 provides results that are substantially equivalent to n=3.

### Example 4

Trials of oleyl ether polyglycol carboxylic acid with n=2 and n=5 and n=10 were tried alone and in combination at 1.25% by weight with EPAM 1 to see whether the degree of ethoxylation that yields superior results can be achieved by mixing oleyl ether polyglycol carboxylic acid materials of different ethoxylation levels. The results of Appearance and Anton Paar Viscosity at 100 s−1 (cP) were observed and the results are summarized in Table 4.

TABLE 4

| | | | | | Anton Paar |
|---|---|---|---|---|---|
| Ex- | | | | | Viscosity |
| am- | Combination | | | | at 100 s⁻¹ |
| ple | of products | EO | HLB | Appearance | (cP) |
| C22 | Oleyl ether polyglycol | 2.0 | 4.9 | Gel | 4.4 |
| | carboxylic acid EO2 | | | | |
| E23 | Oleyl ether polyglycol | 3.5 | 7.3 | Fluid | 4.2 |
| | carboxylic acid | | | | |
| | EO2:EO5 = 50:50 | | | | |
| | (by weight) | | | | |
| E24 | Oleyl ether polyglycol | 5.0 | 9 | Fluid | 4.1 |
| | carboxylic acid EO5 | | | | |
| C25 | Oleyl ether polyglycol | 7.5 | 11 | Gel | 4.3 |
| | carboxylic acid | | | | |
| | E05:EO10 = 50:50 | | | | |
| | (by weight) | | | | |
| C26 | Oleyl ether polyglycol | 10.0 | 12.4 | Gel | 4.3 |
| | carboxylic acid EO10 | | | | |

The data of Table 4 show that the n value of alkoxylation in oleyl ether polyglycol carboxylic acid that yields desired results can be attained by weight averaging oleyl ether polyglycol carboxylic acids with n values that might not, individually, provide desired results.

Viewing the data of all the examples together, it would be evident to one of skill in the art that the compositions of EPAM 1, 2 and 3, and the brine of Table 1B represent only specific simulations of the utility of the various embodiments of this invention, such that with variations in brine composition or in the sulfonate terpolyacrylamide water-in-oil emulsions, or when combined with other conventional surfactants, the performance of oleyl ether polyglycol carboxylic acids will not be strictly limited to n having a value of precisely from 3 to 5 (inclusive) or HLB of from precisely 5 to 9.6 inclusive, and/or at loadings of less than 1 wt % or more than 3 wt %, but rather, surprisingly superior results may be attained somewhat beyond those metrics, which should not be viewed as critical limitations.

### Example 5

A series of aqueous test brines was prepared using the salts of Table 1B in the amounts indicated in Table 5A:

TABLE 5A
Brine Ion Concentrations (PPM)

| Brine | Na⁺ | K⁺ | Mg⁺⁺ | Ca⁺⁺ | Sr⁺⁺ | Ba⁺⁺ | Fe⁺⁺ | Mn⁺⁺ | B⁺⁺⁺ | C⁻ | HCO₃⁻ | SO₄⁻⁻ |
|---|---|---|---|---|---|---|---|---|---|---|---|---|
| A | 35 | 4 | 4 | 40 | — | — | — | — | — | 41 | 132 | 30 |
| B | 4,006 | 31 | 73 | 867 | — | — | 26 | 1 | 9 | 7,649 | 386 | 115 |
| C | 13,034 | 148 | 14 | 5,654 | — | 1,400 | — | — | — | 30,960 | — | 57 |
| D | 32,179 | — | — | 5,725 | — | — | — | — | — | 59,750 | — | — |
| E | 40,916 | 648 | 532 | 3,804 | 1,105 | — | — | — | — | 72,604 | 189 | 197 |
| F | 42,042 | 3,608 | 519 | 9,574 | 799 | — | 125 | — | — | 86,945 | — | 564 |
| G | 67,774 | 960 | 425 | 2,256 | — | 2 | 27 | — | — | 110,041 | 161 | 704 |
| H | 67,656 | — | 2,721 | 22,751 | — | — | — | — | — | 152,521 | — | — |

A volume of sample E21 from Example 3 was prepared and dosed in each of the brines A-H at 0.5 gpt, and Friction Reduction was tested as described in Example 1 with the results presented in Table 5B:

TABLE 5B
Friction reduction result in various brines

| | Total Hardness | Total | Max | Time | Time |
|---|---|---|---|---|---|
| | as CaCO₃ | Dissolved | FR | to max | to 90% |
| Brine | (ppm) | Solids (ppm) | (%) | FR (s) | max FR (s) |
| A | 117 | 286 | 65 | 56 | 28 |
| B | 2,468 | 13,161 | 65 | 44 | 24 |
| C | 14,194 | 51,268 | 65 | 46 | 28 |
| D | 14,311 | 97,652 | 64 | 68 | 40 |
| E | 11,701 | 119,994 | 64 | 70 | 42 |
| F | 26,074 | 144,301 | 62 | 102 | 56 |
| G | 7,393 | 182,352 | 63 | 116 | 62 |
| H | 68,088 | 245,648 | 59 | 230 | 72 |

The data of Table 5B show that a treatment fluid according to an embodiment of the disclosure functions as well in relatively fresh water as it does at higher salinity. In particular, this data shows that the right choice of surfactant and an inverting surfactant HLB of <10 works in various TDS brines.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A treatment fluid comprising an emulsion, the emulsion comprising:
water;
a water-immiscible liquid;
poly(acrylamide-acrylic acid-acrylamide tertiary butyl sulfonic acid), and oleyl ether polyglycol carboxylic acid component of formula RO(CH₂CH₂O)n-CH₂COOH, in an amount of from about 1 wt % to about 3 wt % (by weight of the emulsion composition) and salts or esters thereof, where n=about 3 to about 7.

2. The treatment fluid of claim 1, wherein n=about 3 to about 5.

3. The treatment fluid of claim 1, wherein n is 3, 4 or 5.

4. The treatment fluid of claim 1, wherein the oleyl ether polyglycol carboxylic acid has a hydrophilic-lipophilic balance of about 5 to about 10.

5. The treatment fluid of claim 3, wherein the oleyl ether polyglycol carboxylic acid has a hydrophilic-lipophilic balance of 5 to 9.6.

6. The treatment fluid of claim 1, comprising oleyl ether polyglycol carboxylic acids having different n values which in combination result in a weight average of n=about 3 to about 7.

7. The treatment fluid of claim 1, comprising oleyl ether polyglycol carboxylic acids having different n values which in combination result in a weight average of n=about 3 to about 5.

8. A method of forming a self-inverting poly(acrylamide-acrylic acid-acrylamide tertiary butyl sulfonic acid) water-in-oil emulsion, comprising adding to the water-in-oil emulsion an oleyl ether polyglycol carboxylic acid component of formula RO(CH₂CH₂O)n-CH₂COOH, in an amount of from about 1 wt % to about 3 wt % (by weight of the emulsion composition) and salts or esters thereof, where n=about 3 to about 7.

9. The method of claim 8 wherein about 3 to about 5.

10. The method of claim 8 wherein n is 3, 4 or 5.

11. The method of claim 8 wherein the oleyl ether polyglycol carboxylic acid has a hydrophilic-lipophilic balance of about 5 to about 10.

12. The method of claim 8 wherein the oleyl ether polyglycol carboxylic acid has a hydrophilic-lipophilic balance of 5 to 9.6.

13. The method of claim 8, comprising adding oleyl ether polyglycol carboxylic acids having different n values which in combination result in a weight average of n=about 3 to about 5.

14. A method of treating a subterranean formation, comprising: providing a treatment fluid of claim 1 and introducing the treatment fluid into a subterranean formation.
